(19) United States
(12) Patent Application Publication
(10) Pub. No.: US 2006/0143505 A1
(43) Pub. Date: Jun. 29, 2006

(54) Method of providing data security between raid controller and disk drives

(75) Inventors: Sompong Paul Olarig, Pleasanton, CA (US); Jacob Cherian, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/021,495

(22) Filed: Dec. 22, 2004

(51) Int. Cl. G06F 11/00

(52) U.S. Cl. 714/6

(57) ABSTRACT

A method of providing data security between RAID controller and disk drives is disclosed. In accordance with one embodiment, a method of providing data security between a redundant array of inexpensive/independent disk (RAID) controller and disk drives in an information handling system includes assigning a key from a plurality of keys in the RAID controller. The key scrambles data written to a disk drive in a RAID. The method further including scrambling the data sent from the RAID controller to the disk drive such that the scrambling operably changes the pattern of the data written to the disk drive such that the data is readable from the disk drive by using the key to descramble the data. The method further including storing the data on the disk drive, reading the data from the disk drive and unscrambling the data received from the disk drive based on the key.

### TECHNICAL FIELD

The present disclosure relates generally to information handling systems and, more particularly, to a method of providing data security between RAID controller and disk drives.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including computer systems, typically include storage disk drives and in some instances an array of disk drives. For example, an redundant array of inexpensive/independent disk (RAID) drives may be communicatively coupled to the information handling system for data storage and retrieval.

Because of consumer demand for smaller and more portable computer components, manufacturers developed interchangeable modular drives for use as RAID drives. The RAID drives are typically manufactured as plug-and-play or hot-swappable drives that allow a user to remove and/or replace drives without affecting the other part of the information handling system (e.g., serial advanced [SATA] and Serial Attached SCSI) Due in part to this feature, the vulnerability of the drives to theft has increased.

Although the loss of the drive is expensive, another drive can replace the missing or lost drive. Unfortunately, the information contained on the drive is lost and in some instances irreplaceable. For example, confidential information or intellectual property such as trade secrets or computer code is much more difficult, sometimes impossible to replace. Further, the lost drive may contain information that allows a competitors in the industry to cause economic damage to the company that lost the drive.

### SUMMARY

In accordance with one embodiment of the present disclosure, a method of providing data security between a redundant array of independent disk (RAID) controller and disk drives in an information handling system including assigning a key from a plurality of keys in the RAID controller. The key scrambles data written to a disk drive in a RAID. The method further including scrambling the data sent from the RAID controller to the disk drive, wherein the scrambling changes the pattern of the data written to the disk drive such that the data is readable from the disk drive by using the key to descramble the data. The method further including storing the data on the disk drive and reading the data from the disk drive. The method further including unscrambling the data received from the disk drive based on the key.

In a further embodiment, an information handling system includes a processor coupled to a processor bus and a memory coupled to the processor bus. The memory communicatively coupled with the processor. The information handling system further comprising a redundant array of independent disk (RAID) controller communicately coupled to the processor bus. The RAID controller including a plurality of keys. Each of the keys including an algorithm to scramble/descramble data written to a disk drive in a RAID, such that one of the keys selected from the plurality of keys. The selected key operably scrambles the data being written to the disk drive. The selected key operably unscramble the scrambled data read from the disk drive such that the data is readable from the disk drive only by using the key to descramble the data.

In accordance with a further embodiment of the present disclosure, a computer-readable medium having computer-executable instructions for a method of providing data security between a redundant array of independent disk (RAID) controller and disk drives in an information handling system including instructions for assigning a key from a plurality of keys in the RAID controller. The key able to scramble data written to a disk drive in a RAID. The computer-readable medium further including instructions for scrambling the data sent from the RAID controller to the disk drive, wherein the scrambling operably changes the pattern of the data written to the disk drive such that the data is readable from the disk drive by using the key to descramble the data. The computer-readable medium further including instructions for storing the data on the disk drive and instructions for reading the data from the disk drive. The computer-readable medium further including instructions for unscrambling the data received from the disk drive based on the key.

One technical advantage of the present disclosure is the ability to provide data security without placing the burden on the user. Because a user may select or have the key assigned for scrambling data, a RAID controller may automatically scramble data written to a disk drive in a RAID. As such, the burden of maintaining security for the data on the drives may be controlled by the RAID controller without much user interaction.

Another technical advantage of some embodiments of the present disclosure is the ability to provide a unique serial attached small computer system interface (SAS) or serial advanced technology attachment (SATA) security feature between a RAID controller and the SAS/SATA drives. Because data encryption techniques may employ several different algorithms, the technique may take advantage of the scrambling techniques used to prevent electromagnetic interference (EMI) in addition with other encryption techniques may be used to encrypt data written to the disk drives. Thus, the implementation of current scrambling techniques may be applied to further scramble or encrypt data using various algorithms for security purposes.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram showing an information handling system, according to teachings of the present disclosure;

FIG. 2 illustrates an example embodiment of a redundant array of independent disk (RAID) controller coupled to disk drives of a RAID drive in the information handling system, according to teachings of the present disclosure;

FIG. 3 illustrates another example embodiment of a RAID controller coupled to disk drives of a RAID drive in the information handling system, according to teachings of the present disclosure;

FIG. 4 is a flowchart for a method of providing data security between a redundant array of independent disk (RAID) controller and disk drives in an information handling system, according to teachings of the present disclosure;

FIG. 5 is a conventional method of writing data to RAID disk drives; and

FIG. 6 illustrates one example embodiment of writing data to RAID disk drives using a RAID controller using a scrambling key an information handling system, according to teachings of the present disclosure.

### DETAILED DESCRIPTION

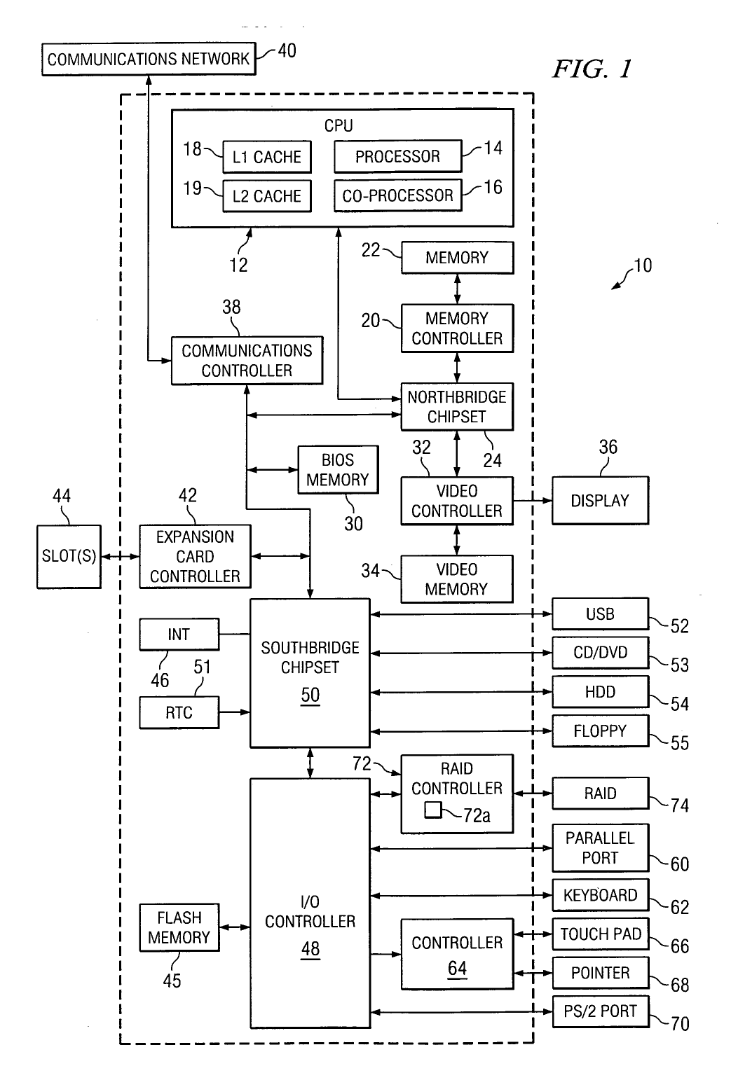

Preferred embodiments and their advantages are best understood by reference to FIGS. 1 through 6, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of information handling system 10 is shown, according to teachings of the present disclosure. Information handling system 10 or computer system preferably includes one or more microprocessors such as central processing unit (CPU) 12. CPU 12 may include processor 14 for handling integer operations and coprocessor 16 for handling floating point operations. CPU 12 is preferably coupled to cache, such as L1 cache 18 and L2 cache 19 and a chipset, commonly referred to as Northbridge chipset 24, via a frontside bus 23. Northbridge chipset 24 preferably couples CPU 12 to memory 22 via memory controller 20. Main memory 22 of dynamic random access memory (DRAM) modules may be divided into one or more areas such as system management mode (SMM) memory area (not expressly shown).

Graphics controller 32 is preferably coupled to Northbridge chipset 24 and to video memory 34. Video memory 34 is preferably operable to store information to be displayed on one or more display panels 36. Display panel 36 may be an active matrix or passive matrix liquid crystal display (LCD), a cathode ray tube (CRT) display or other display technology. In selected applications, uses or instances, graphics controller 32 may also be coupled to an integrated display, such as in a portable information handling system implementation.

Northbridge chipset 24 serves as a “bridge” between CPU bus 23 and the connected buses. Generally, when going from one bus to another bus, a bridge is needed to provide the translation or redirection to the correct bus. Typically, each bus uses its own set of protocols or rules to define the transfer of data or information along the bus, commonly referred to as the bus architecture. To prevent communication problem from arising between buses, chipsets such as Northbridge chipset 24 and Southbridge chipset 50, are able to translate and coordinate the exchange of information between the various buses and/or devices that communicate through their respective bridge.

Basic input/output system (BIOS) memory 30 is also preferably coupled to PCI bus 25 connecting to Southbridge chipset 50. FLASH memory or other reprogrammable, nonvolatile memory may be used as BIOS memory 30. A BIOS program (not expressly shown) is typically stored in BIOS memory 30. The BIOS program preferably includes software which facilitates interaction with and between information handling system 10 devices such as a keyboard 62, a mouse such as touch pad 66 or pointer 68, or one or more I/O devices. BIOS memory 30 may also store system code (note expressly shown) operable to control a plurality of basic information handling system 10 operations.

Communication controller 38 is preferably provided and enables information handling system 10 to communicate with communication network 40, e.g., an Ethernet network. Communication network 40 may include a local area network (LAN), wide area network (WAN), Internet, Intranet, wireless broadband or the like. Communication controller 38 may be employed to form a network interface for communicating with other information handling systems (not expressly shown) coupled to communication network 40.

In certain information handling system embodiments, expansion card controller 42 may also be included and is preferably coupled to PCI bus 25 as shown. Expansion card controller 42 is preferably coupled to a plurality of information handling system expansion slots 44. Expansion slots 44 may be configured to receive one or more computer components such as an expansion card (e.g., modems, fax cards, communications cards, and other input/output (I/O) devices).

Southbridge chipset 50, also called bus interface controller or expansion bus controller preferably couples PCI bus 25 to an expansion bus. In one embodiment, expansion bus may be configured as an Industry Standard Architecture (“ISA”) bus. Other buses, for example, a Peripheral Component Interconnect (“PCI”) bus, may also be used.

Interrupt request generator 46 is also preferably coupled to Southbridge chipset 40. Interrupt request generator 46 is preferably operable to issue an interrupt service request over a predetermined interrupt request line in response to receipt of a request to issue interrupt instruction from CPU 12. Southbridge chipset 40 preferably interfaces to one or more universal serial bus (USB) ports 52, CD-ROM (compact disk-read only memory) or digital versatile disk (DVD) drive 53, an integrated drive electronics (IDE) hard drive device (HDD) 54 and/or a floppy disk drive (FDD) 55. In one example embodiment, Southbridge chipset 40 interfaces with HDD 54 via an IDE bus (not expressly shown). Other disk drive devices (not expressly shown) which may be interfaced to Southbridge chipset 40 include a removable hard drive, a zip drive, a CD-RW (compact disk-read/write) drive, and a CD-DVD (compact disk-digital versatile disk) drive.

Real-time clock (RTC) 51 may also be coupled to Southbridge chipset 50. Inclusion of RTC 74 permits timed events or alarms to be activated in the information handling system 10. Real-time clock 74 may be programmed to generate an alarm signal at a predetermined time as well as to perform other operations.

I/O controller 48, often referred to as a super I/O controller, is also preferably coupled to Southbridge chipset 50. I/O controller 48 preferably interfaces to one or more parallel port 60, keyboard 62, device controller 64 operable to drive and interface with touch pad 66 and/or pointer 68, and PS/2 Port 70. FLASH memory or other nonvolatile memory may be used with I/O controller 48.

Generally, chipsets 24 and 50 may further include decode registers to coordinate the transfer of information between CPU 12 and a respective data bus and/or device. Because the number of decode registers available to chipset 24 or 50 may be limited, chipset 24 and/or 50 may increase the number or I/O decode ranges using system management interrupts (SMI) traps.

Redundant array of inexpensive/independent disk (RAID) controller 72 generally interfaces between I/O controller 48 and RAID 74. RAID controller 72 generally presents all of the disks/drives under its control to information handling system 10 as a single logical unit. In some embodiments, RAID controller 72 includes a computer card that connects to an I/O slot coupled to I/O controller 48. However, in other embodiments, RAID controller 72 may be placed external to information handling system 10 such that it couples to a regular drive controller for interfacing with I/O controller 48.

Typically, RAID controller 72 includes controller software 72a, such as a driver programs or controllers, that may be used to scramble or encrypt data passing through RAID controller 72 to be written to one or more drives of RAID 74. In other instances, the scrambling or encrypting of the data may be performed using hardware within RAID 74. RAID 74 typically stores data for information handling system 10 using a category of disk drives that employ two or more disk drives, such as disk drives 74a, in combination for fault tolerance and performance.

Scrambling data, also referred to as data encryption, typically includes the translation of data into a secret code generally for security reasons. Once encrypted, the data must be unscrambled or decrypted to read the data. Generally, the decryption requires the use of a password or key that deciphers the encrypted data back into readable/usable form, commonly referred to as plain text data.

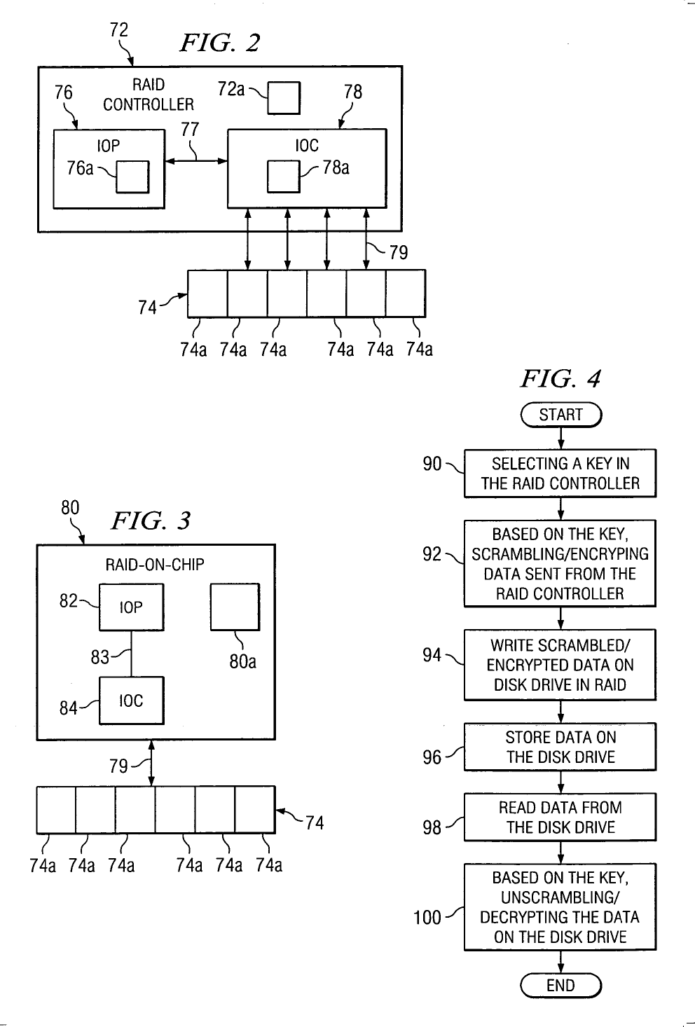

Referring to FIG. 2, RAID controller 72 preferably includes input/output processor (IOP) 76 and I/O controller (IOC) 78 and couple to disk drives 74a in RAID 74 via cable 79. IOP 76 generally controls the interfaces between RAID controller 72 and disk drives 74a of RAID 74. IOC 78 typically is a set of controllers that connect the RAID controller 72 to disk drives 74a such as serial attached small computer system interface (SAS) or serial advanced technology attachment (SATA) disk drives. IOP 76 and IOC 78 may be coupled using bus 77 and used to control and direct the data between information handling system 10 and disk drives 74a.

Generally, bus 77 and cable 79 may transmit data between RAID 74 and RAID controller 72 using an I/O interconnect bus standard such as PCI Extended (PCI-X) or PCI-Express. In some instances, these bus standards may perform some scrambling of the data to prevent the generation of electromagnetic interference (EMI) emissions due to the repetition of data patterns transmitted over a bus. However, the data patterns are only scrambled based on prevention of pattern repetitions without regard to data security. In some aspects of the present disclosure, encryption techniques are combined with PCI-X and/or PCI-Express to facilitate the scrambling of data written to disk drives 74a.

In one embodiment of the present disclosure, an encryption technique may be applied to data using a hardware-assisted technique that is coupled to RAID controller 72. For example, a PERC5 RAID controller may provide security features operable to enable scrambling or encrypting data written to disk drives 74a. In one example embodiment, a user of information handling system 10 may optionally activate data encryption such that IOP 76 and IOC 78 may perform an encryption technique on data being written to disk drives 74a. However, in some instances, the encrypting technique may impact IOP 76.

In another embodiment, the encryption technique may be applied using a firmware-assisted technique. Generally, this approach may allow for existing hardware in a RAID controller to implement the encryption technique without hardware changes or modifications. As such, the firmware may include software programs that cause the data encryption prior to feeding the data to IOC 78.

In other instances, both the hardware-assisted and firmware-assisted techniques may be applied to RAID controller 72 to encrypt data written to disk drives 74a. For example, IOP 76 may include computer code or software 76a and IOC 78 may further include computer code or software 78a that is operable to encrypt/decrypt data being written to/from disk drives 74a.

Referring to FIG. 3, in another example embodiment, RAID controller 80 may be formed as a computer chip such as RAID-on-Chip (ROC) 80. Generally, ROC 80 is formed as a part of a motherboard (not expressly shown) within information handling system 10. As such, ROC 80 may couple to disk drives 74a in RAID 74 via cable 79. ROC 80 may further include IOP 82 and IOC 84 coupled via bus 83. ROC software 80a may also be included as part of the computer chip such that encryption techniques are stored on ROC 80.

FIG. 4 is a flowchart for a method of providing data security between RAID controller 72 or 80 and disk drives 74a in information handling system 10. In some embodiments, the method is stored on computer-readable medium having computer-executable instructions for performing the method.

As shown at block 90, an encryption key is selected and/or assigned in RAID controller 72 or 80. In some embodiments, a user may select, assign or define the encryption key for encrypting or scrambling data. As such, RAID controller 72 or 80 may include several keys or scrambler algorithms able to be selected by the user.

For example, in a cluster mode one or more RAID controllers (not expressly shown) may utilize the same encryption algorithm. In one aspect, algorithms are implemented with a linear feedback shift register (LFSR) such as a 16-bit LFSR that uses the following polynomial equations:
G(x)=Xˆ16+Xˆ5+Xˆ4+Xˆ3+1; and
G(x)=Xˆ16+Xˆ15+Xˆ13+Xˆ4+1,

where the former equation is used for data from a PCI-Express and the latter equation is used for data from SAS disk drives. However, it is appreciated that other polynomial equations or other order equations may be implemented in combination with the present disclosure.

Yet, in other embodiments, the user may select to disable encryption techniques for writing to disk drives 74a. In one aspect, the scrambling or encrypting techniques are disabled to help facilitate testing or debugging such that an information block is not worthy of additional protection.

Based on the selected or assigned key, the data is scrambled or encrypted as it passes through RAID controller 72 or 80, as shown at block 92. The scrambled or encrypted data may then be written to disk drives 74a in RAID 74 as shown at block 94. And, at block 96, the data can be stored on disk drives 74a for later retrieval. Because the data stored on disk drives 74a is encrypted using a secret key, if any one disk drive 74a is stolen, the data when read by another RAID or disk controller without the proper key or descrambler would not produce data in humanly readable data format or any usable format.

At block 98, the data may be requested and read from disk drive 74a. Based on the key, the data is unscrambled or decrypted using the appropriate algorithms to return the data to a usable format, as shown at block 100. Generally, the scrambled data is retrieved from disk drive 74a and decrypted before being sent from RAID controller 74 or 80 to information handling system 10.

At times it may become necessary to remove or replace one of disk drives 74a in RAID 74. Because the encryption technique may be stored on RAID controller 72 or 80, the new drive may begin to store encrypted or scrambled data without performing any modifications or special formatting. However, for the removed disk drive 74a, the data may be encrypted such that a proper key must be used to read the data from the removed drive.

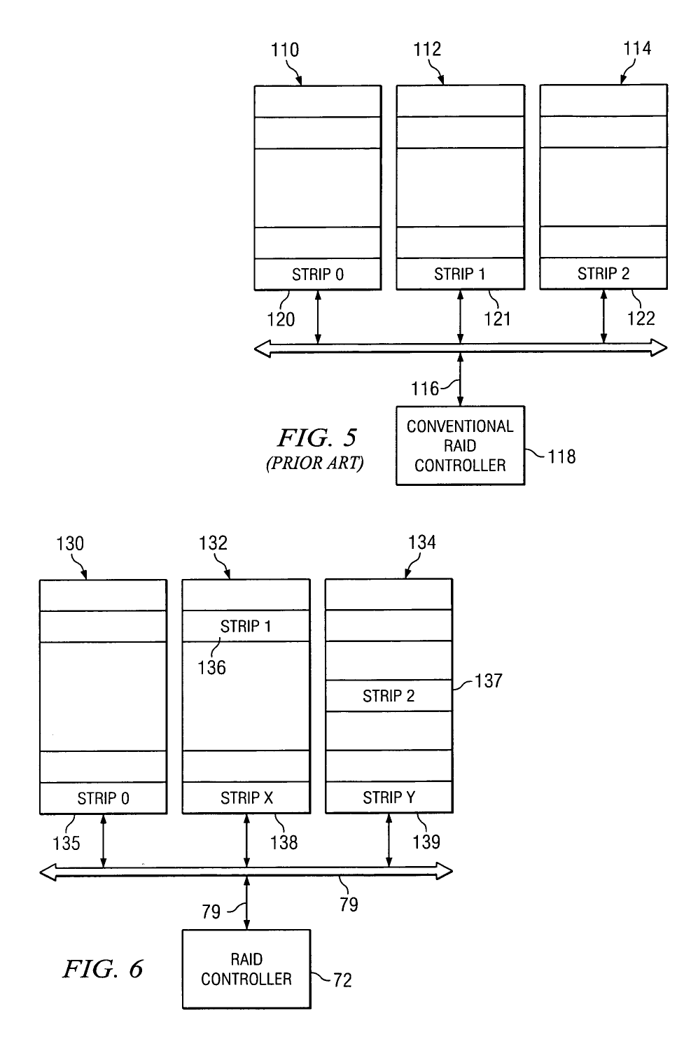

FIG. 5 is a conventional method of writing data to RAID disk drives 110, 112 and 114. Current methods of writing data to RAID disk drives 110, 112 and 114 typically includes sending the data from conventional RAID controller 118 along bus 116 to RAID disk drives 110, 112 and 114. The data may be stored across drives 110, 112 and 114 in a strip format in sequential order. As such, the sequentially written data may be formed across drives 110, 112 and 114 in logical order.

For example, the data may be parceled into three separate data strips, namely “Strip 0”, “Strip 1”, and “Strip 2”. “Strip 0” may be written to RAID disk drive 110 at disk location 120 and “Strip 1” may be written at sequential disk location 121 on RAID disk drive 112. “Strip 2” may be written at disk location 122 on RAID disk drive 114. Because all the data was written or stored in sequential form, removal of one disk may still allow for the data to be recovered since the missing elements may be filled in using standard decryption or recovery programs.

Referring to FIG. 6, RAID controller 72 may be used to transform or scramble data written to RAID disk drives 130, 132 and 134 using scrambling keys such as a selected polynomial equation. Scrambled data is typically sent from RAID controller 72 along cable 79 and written to RAID disk drive 130, 132 and 134. As previously discussed, the data may be transformed or scrambled according to a prescribed equation such that the data written to RAID disk drives 130, 132 and 134 is randomized and unreadable unless decoded by RAID controller 72.

For example, data may be parceled into separate data strips, namely “Strip 0”, “Strip 1”, and “Strip 2”. “Strip 0” may be written to RAID disk drive 130 at disk location 135. Because of the scrambling, “Strip 1” may be written at place at a random location on RAID disk drive 132 such as at disk location 136. Lastly, “Strip 2” may be written at a random location on RAID disk drive 134 such as at disk location 137.

Because the data is randomly placed according to a selected polynomial equation, removal of one disk may prevent recovery or decryption of the data due to the scrambled format. For example, a decryption program may attempt to read data across the drives as if the data were stored sequentially. Thus, the program would attempt to decrypt the data using information, namely “Strip X”, stored in disk location 138 on RAID disk drive 132 as the following data strip for data “Strip 0” written at disk location 135. Because data “Strip X” is not associated with data “Strip 0”, any attempt to decrypt the removed drive may fail. Therefore, by scrambling the data across the various drives associated with RAID controller 72, any data retrieved from the drives must be decrypted using the correct key stored in RAID controller 72.

Although the disclosed embodiments have been described in detail, it should be understood that various changes, substitutions and alterations can be made to the embodiments without departing from their spirit and scope.

What is claimed is:

1. A method of providing data security between a redundant array of independent disk (RAID) controller and disk drives in an information handling system, comprising:
assigning a key from a plurality of keys in the RAID controller, the key operable to scramble data written to a disk drive in a RAID;
scrambling the data sent from the RAID controller to the disk drive, wherein the scrambling operably changes the pattern of the data written to the disk drive such that the data is readable from the disk drive by using the key to descramble the data;
storing the data on the disk drive;
reading the data from the disk drive; and
unscrambling the data received from the disk drive based on the key.

2. The method of claim 1, wherein the key comprises an algorithm.

3. The method of claim 2, wherein the algorithm further comprising a linear feedback shift register.

4. The method of claim 3, wherein assigning the key further comprises allowing a user to interactively define the key.

5. The method of claim 1, further comprising selecting the key during an initialization of a RAID.

6. The method of claim 1, further comprising disabling the key to allow testing and/or debugging of the information handling system.

7. The method of claim 1, wherein scrambling further comprises encrypting the data between the RAID controller and the disk drives.

8. The method of claim 1, further comprising reducing the generation of repetition patterns to decrease the electro-magnetic interference emission from a transmitted data stream.

9. An information handling system, comprising:
a processor coupled to a processor bus;
a memory coupled to the processor bus, the memory communicatively coupled with the processor;
a redundant array of independent disk (RAID) controller communicately coupled to the processor bus;
the RAID controller including a plurality of keys, each of the keys including an algorithm to scramble/descramble data written to a disk drive in a RAID, wherein one of the keys selected from the plurality of keys;
the selected key operably scrambles the data being written to the disk drive; and
the selected key operably unscramble the scrambled data read from the disk drive such that the data is readable from the disk drive only by using the key to descramble the data.

10. The information handling system of claim 9, further comprising an input/output (I/O) processor communicatively coupled to between the RAID controller and the disk drive in the RAID.

11. The information handling system of claim 9, further comprising an input/output (I/O) controller communicatively coupled to between the RAID controller and the disk drive in the RAID.

12. The information handling system of claim 9, further comprising a RAID-on-Chip (ROC) communicatively coupled to between the RAID controller and the disk drive in the RAID, the ROC including an input/output (I/O) processor and an input/output (I/O) controller forming a part of the ROC.

13. The information handling system of claim 9, wherein the algorithm further comprises a linear feedback shift registers.

14. The information handling system of claim 13, wherein the linear feedback shift registers further comprises implementing the algorithm using polynomials.

15. A computer-readable medium having computer-executable instructions for a method of providing data security between a redundant array of independent disk (RAID) controller and disk drives in an information handling system, comprising:
instructions for assigning a key from a plurality of keys in the RAID controller, the key operable to scramble data written to a disk drive in a RAID;
instructions for scrambling the data sent from the RAID controller to the disk drive, wherein the scrambling operably changes the pattern of the data written to the disk drive such that the data is readable from the disk drive by using the key to descramble the data;
instructions for storing the data on the disk drive;
instructions for reading the data from the disk drive; and
instructions for unscrambling the data received from the disk drive based on the key.

16. The computer-readable medium of claim 15, further comprising instructions for allowing a user to interactively define the key.

17. The computer-readable medium of claim 16, further comprising instructions for selecting the key during an initialization of a RAID.

18. The computer-readable medium of claim 15, further comprising instructions for disabling the key to allow testing and/or debugging of the information handling system.

19. The computer-readable medium of claim 15, wherein instructions for scrambling further comprises instructions for encrypting the data between the RAID controller and the disk drives.

20. The computer-readable medium of claim 15, further comprising instructions for implementing the algorithm using a linear feedback shift register.
